(19) United States
(12) Patent Application Publication
(10) Pub. No.: US 2026/0213816 A1
(43) Pub. Date: Jul. 23, 2026

(54) WLAN MULTI-AP CHANNEL ESTIMATION

(71) Applicant: MaxLinear, Inc., Carlsbad, CA (US)

(72) Inventors: Avi Avraham Mansour, Givat-Shmuel (IL); Rainer Strobel, München (DE); Ziv Avital, Kadima (IL); Sigurd Schelstraete, Menlo Park, CA (US)

(73) Assignee: MaxLinear, Inc., Carlsbad, CA (US)

(21) Appl. No.: 19/449,313

(22) Filed: Jan. 14, 2026

Related U.S. Application Data
(60) Provisional application No. 63/745,262, filed on Jan. 14, 2025.

(51) Int. Cl. H04B 7/06

(52) U.S. Cl. CPC H04B 7/0626; H04B 7/0617

(57) ABSTRACT

A system may include a first access point (AP), a second AP, one or more first stations (STAs), and one or more second STAs. The first AP may be operable to transmit a first NDP. The second AP may be operable to transmit a second NDP. The first STAs may be associated with the first AP, and may be operable to transmit first channel state information (CSI) to the first AP and the second AP in response to obtaining a first beamforming report poll (BFRP) from the first AP. The second STAs may be associated with the second AP, and may be operable to transmit second CSI to the first AP and the second AP in response to obtaining a second BFRP from the second AP. The first NDP and the second NDP may be transmitted at non-overlapping time intervals.

### CROSS REFERENCE TO RELATED APPLICATIONS

This U.S. patent application claims priority to U.S. Provisional Patent Application No. 63/745,262, titled “WLAN MULTI-AP CHANNEL ESTIMATION,” and filed on Jan. 14, 2025, the disclosure of which is hereby incorporated by reference in its entirety.

### TECHNICAL FIELD

This disclosure relates to channel estimation, and more specifically, to wireless local area network (WLAN) multi-access point (AP) channel estimation.

### BACKGROUND

Unless otherwise indicated herein, the materials described herein are not prior art to the claims in the present application and are not admitted to be prior art by inclusion in this section.

Multi-access point (AP) coordination is a key feature of ultra-high reliability wireless local area network (WLAN). For some of the multi-AP coordination schemes, such as coordinated beamforming, spatial nulling, and/or joint transmission, joint sounding from multiple access points may be needed.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

In an example embodiment, a system may include a first access point (AP), a second AP, one or more first stations (STAs), and one or more second STAs. The first AP may be operable to transmit a first null data packet (NDP). The second AP may be operable to transmit a second NDP. The first STAs may be associated with the first AP, and may be operable to transmit first channel state information (CSI) to the first AP and the second AP in response to obtaining a first beamforming report poll (BFRP) from the first AP. The second STAs may be associated with the second AP and may be operable to transmit second CSI to the first AP and the second AP in response to obtaining a second BFRP from the second AP. The first NDP and the second NDP may be transmitted at non-overlapping time intervals.

In another embodiment, an AP may include a transceiver and a processing device. The transceiver may be operable to communicate with at least a second AP and one or more first STAs. The processing device may be operable to transmit a first NDP. The processing device may also be operable to transmit a first BFRP. The processing device may further be operable to obtain first CSI from the first STAs in response to the first STAs obtaining the first BFRP. The processing device may also be operable to obtain second CSI from one or more second STAs in response to the second STAs obtaining a second BFRP transmitted by the second AP. The first NDP may be transmitted at a non-overlapping time interval with a second NDP transmitted by the second AP.

In another embodiment, a method may include transmitting a first NDP to one or more first STAs by a first AP. The method may also include transmitting a first BFRP to the first STAs by the first AP. The method may further include obtaining CSI from the first STAs in response to the first STAs obtaining the first BFRP. The method may also include obtaining second CSI from one or more second STAs in response to the second STAs obtaining a second BFRP transmitted by a second AP. The first NDP may be transmitted at a non-overlapping time interval with a second NDP transmitted by the second AP.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example system for wireless local area network (WLAN) multi-access point (AP) channel estimation;

FIG. 2 illustrates another example system for WLAN multi-AP channel estimation;

FIG. 3 illustrates another example system for WLAN multi-AP channel estimation;

FIGS. 4A-4C illustrate example null data packets that may be used in a WLAN multi-AP channel estimation system;

FIG. 5 illustrates example data rates associated with joint sounding and multi-AP channel estimation;

FIGS. 6A-6B illustrate results associated with a joint optimization technique for joint sounding and multi-AP channel estimation;

FIG. 7 illustrates a flowchart of an example method for WLAN multi-AP channel estimation; and

FIG. 8 illustrates an example computing device.

### DETAILED DESCRIPTION

Joint sounding may utilize two or more access points (APs) to transmit the channel estimation packets (e.g., channel state information (CSI) packets) at approximately the same time. At each transmit antenna and each AP, a different sequence may be transmitted, such that at the receiver side, the signals can be separated for multiple-input multiple-output (MIMO) channel estimation. In some instances, the sounding overhead may need to be considered to determine performance. Alternatively, or additionally in some instances, the clock synchronization between joint sounding APs may be a non-trivial requirement. In some instances, coordinated beamforming performance may depend on a sounding and precoding algorithm. Joint sounding may allow partial rank nulling, but may not perform well without joint optimization. Sequential sounding without partial rank nulling may be limited to 1-antenna stations (STAs) and 2-spatial stream transmissions.

A carrier frequency offset between multiple simultaneously transmitting APs may cause a channel estimation error, because the STA receiver may be operable to lock only to one frequency. Alternatively, or additionally, different clocks may cause a rotation of the received quadrature amplitude modulation (QAM) symbols, relative to each other at the STA. In instances in which a system includes two APs (with four antennas), four STAs (with two antennas), and one or two spatial streams (e.g., at 160 MHz), sounding feedback overhead of the joint sounding may be prohibitive. For example, the overhead may be approximately 4 ms, if all STAs transmit feedback at different times and/or at a minimum rate. More aggressive rates may be problematic as feedback may need to be received by both APs. In some instances, a sequential sounding method may be used which may result in a lower overhead time (e.g., approximately 1.8 ms in a similar arrangement). In such instances, feedback to unassociated APs (e.g., intra-overlapping basic service set (OBSS)) may be inefficient (e.g., per-antenna feedback may be needed and/or a conservative modulation coding scheme, as the channel may not be known).

In instances in which sequential sound may not facilitate partial rank nulling, the lack thereof may be resolved by defining a new feedback report for intra-OBSS feedback. In such instances, the associated STA channel may be represented by:

$${H}_{s 1 a 1} = {U}_{s 1 a I} {S}_{s 1 a 1} {V}_{s 1 a 1}^{H} ,$$

the intra-OBSS feedback may be represented by

$${H}_{s 1 a 2} : {S}_{s 1 a 1}^{- 1} {U}_{s 1 a 1}^{H} {H}_{s 1 a 2} ,$$

and the channel may be:

$$[ \begin{matrix}{H}_{s 1 a 1} & {H}_{s 1 a 2} \\ {H}_{s 2 a 1} & {H}_{s 2 a 2}\end{matrix} ] .$$

Joint sounding with two compete sounding sequences, one for each AP, may currently be utilized to overcome the issue of communication over basic service set (BSS) boundaries. But in such sequence, the null data packets (NDPs) may be transmitted twice, only to avoid the requirement for STAs to receive NDP announcement (NDPA) packets from unassociated APs.

In joint sounding, a clock offset between the two APs may cause a channel estimation error, because the STAs may be capable of locking to one of the APs at a time. Alternatively, or additionally, due to the duration of the joint sounding long training fields (LTFs), the frequency drift within the LTFs may cause a performance impact (which may not be an issue for sequential sounding).

Another issue that may be present may be coordinated beamforming performance, as the performance may depend on receiver equalization of multi-antenna STAs. Joint sounding may be represented by:

$${G}_{s} = {S}_{s}^{- 1} {U}_{s}^{H} ,$$

independent sounding may be represented by:

$${G}_{s} = {S}_{s a}^{- 1} {U}_{s a}^{H} ,$$

and joint optimization may be Gₛ jointly optimized for all STAs m=1, . . . , M in view of the following:

$$G = [ \begin{matrix}{G}_{1} & 0 & … & 0 \\ 0 & {G}_{2} & ⋱ & ⋮ \\ ⋮ & ⋱ & {G}_{3} & 0 \\ 0 & … & 0 & {G}_{4}\end{matrix} ] , {P}_{a} = {( G [ \begin{matrix}{H}_{1 a} \\ {H}_{2 a} \\ {H}_{3 a} \\ {H}_{4 a}\end{matrix} ] )}^{- 1} , {G}_{s} = [ {g}_{s 1} {g}_{s 2} ]$$

The optimization may be performed by fixing gₛ₁ and searching gₛ₂ for a best conditioning of Pₐ matrix inversion, for example, by the iterative phase optimization (IPO) method.

The NDPs may be modulated with an orthogonal code, as shown in Table 1. Each AP may transmit the corresponding rows of the orthogonal code at the APs antennas. Two APs with four antennas each, may use an 8×8 orthogonal sequence.

TABLE 1

| | | | | | | | | |
|---|---|---|---|---|---|---|---|---|
| AP1 | 1 | −1 | 1 | 1 | 1 | −1 | 1 | 1 |
| | 1 | 1 | −1 | 1 | 1 | 1 | −1 | 1 |
| | 1 | 1 | 1 | −1 | 1 | 1 | 1 | −1 |
| | −1 | 1 | 1 | 1 | −1 | 1 | 1 | 1 |
| AP2 | 1 | −1 | 1 | 1 | −1 | 1 | −1 | −1 |
| | 1 | 1 | −1 | 1 | −1 | −1 | 1 | −1 |
| | 1 | 1 | 1 | −1 | −1 | −1 | −1 | 1 |
| | −1 | 1 | 1 | 1 | 1 | −1 | −1 | −1 |

The present disclosure addresses these and other limitation by using a joint sounding NDP transmission that may be partitioned into two sections, where only one AP may be transmitting at a time. In such an arrangement, a STA may lock to the carrier frequency of one AP and may receive the corresponding signal. In some instances, the partitioning of the NDP transmission may be implemented with an orthogonal sequence that may include zero-symbols for one AP, while the other AP transmits non-zero symbols. Alternatively, or additionally, the partitioning of the NDP transmission may be implemented by the APs transmitting a shorter NDP, where one NDP is transmitted after another.

Further, the present disclosure includes a channel estimation sequence, where multi-AP joint sounding can be performed without very strict requirements on clock synchronization between APs. A carrier frequency offset between the APs may not harm the quality of the channel estimation. Alternatively, or additionally, the APs may not transmit the channel estimation symbols simultaneously, which may reduce or remove the need to perform power control to limit performance impact due to transmitter and receiver distortion. Alternatively, or additionally, the proposed implementations may combine the advantages of joint and independent sounding, as the full channel information of a joint sounding may be provided, but simultaneous transmission may not need to be maintained.

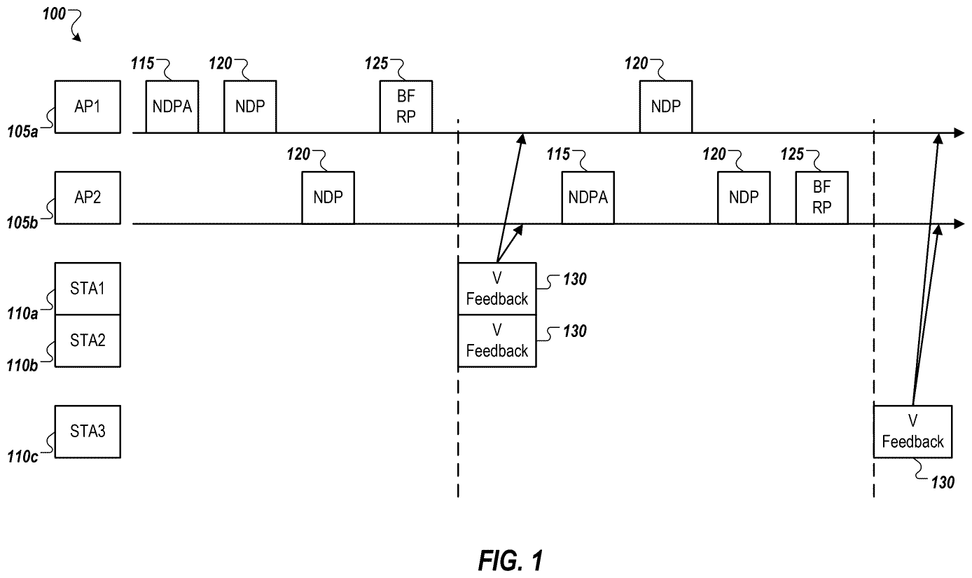

FIG. 1 illustrates an example system 100 for wireless local area network (WLAN) multi-access point (AP) channel estimation. The system 100 may facilitate joint sounding by using a joint sounding sequence where a previous joint sounding NDP may be replaced by two shorter NDPs 120 following the transmission of a NDPA 115, where each of the NDPs 120 may be transmitted by the APs 105 (e.g., the first AP 105a and the second 105b, as illustrated). The joint sounding sequence illustrated in the system 100 may differ from current joint sounding by not having both the first AP 105a and the second AP 105b transmitting the associated NDPs 120 at the same or substantially the same time.

After the first AP 105a transmits the BFRP 125, the STAs 110 associated with the first AP 105a (e.g., the first STA 110a and the second STA 110b) may provide the channel state information (CSI) 130 associated with the channel between the first STA 110a and the second STA 110b, and the first AP 105a. Similarly, the second AP 105b may transmit the NDPA 115, and following both of the APs 105 transmitting the NDPs 120, the second AP 105b may transmit the BFRP 125. In response to obtaining the BFRP 125, the STAs 110 associated with the second AP 105b (e.g., the third STA 110c) may provide the CSI 130 associated with the channel between the STA 110c and the second AP 105b.

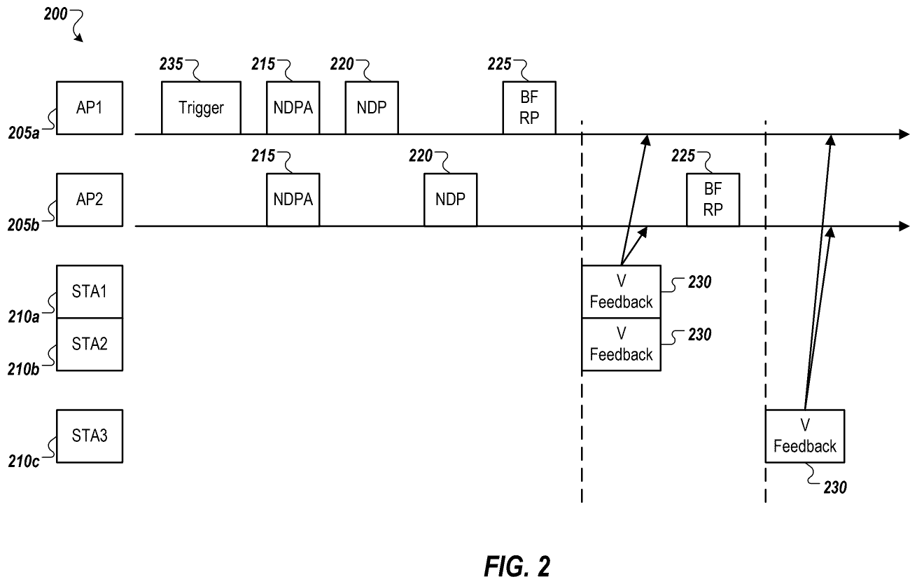

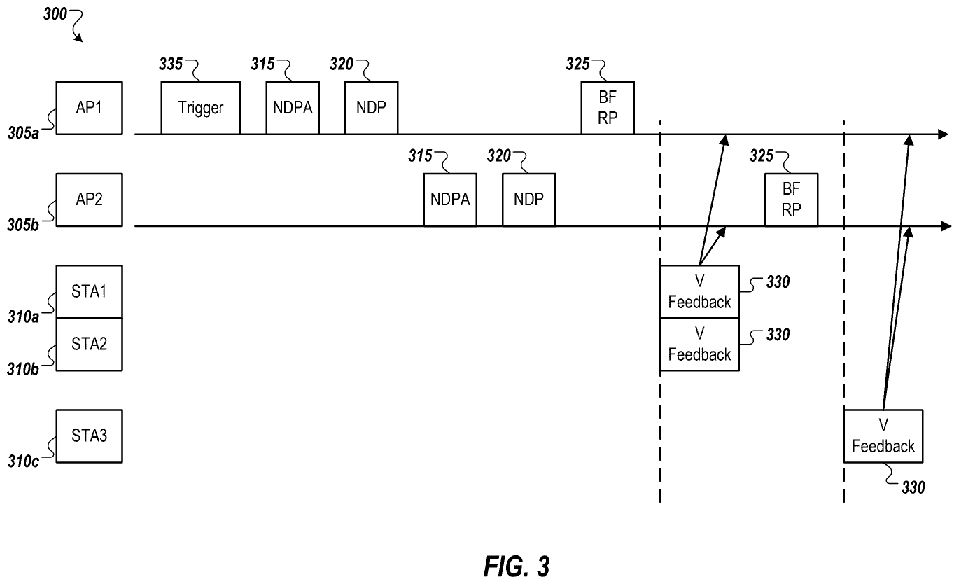

As illustrated, the joint sounding sequence of the system 100 may include double transmissions of the NDPs 120 following each transmission of the NDPA 115, where there may be a transmission for each BSS. In some instances, it may be possible to merge the transmission of the NDPs 120 into a single NDP 120 transmission sequence, where the NDPA 115 packet may be separately repeated by the APs 105. The resultant sounding sequence of merging the NDP 120 transmissions is illustrated and described relative to FIG. 2 and/or FIG. 3.

On each carrier of the WLAN orthogonal frequency-division multiplexing (OFDM) transmission, the transmitter (e.g., the first AP 105a and/or the second AP 105b) may transmit a signal vector, x, with one element per antenna. The signal vector may be transmitted over the MIMO channel matrix, H, where the number of rows may correspond to the number of receive antennas in the STAs 110, and the number of columns may correspond to the number of transmit antennas in the APs 105. Alternatively, or additionally, receiver noise, n, may be present which can be described as a vector with one element per receive antenna. This gives the transmission model according to:

$$y = Hx + n$$

In a multi-AP multiple user (MU)-MIMO downlink transmission, the transmit signal vector may correspond to the signal of all APs 105,

$$( e . g . , = [ \begin{matrix}{x}_{AP 1} \\ {x}_{AP 2}\end{matrix} ] )$$

and the receive signal vector, y, may correspond to the received signal of all STAs 110

$$( e . g . , y = [ \begin{matrix}{y}_{STA 1} \\ ⋮ \\ {y}_{STA M}\end{matrix} ] ) .$$

For channel estimation, the first AP 105a may transmit the NDP 120, which may include one or more training symbols (e.g., LTF symbols). The number of training symbols, T, that may be used for channel estimation may depend on the number of transmit (TX) antennas. For example, eight TX antennas, corresponding to two APs with four antennas each, may use a code as provided below:

$$P = [ {x}^{[ 1 ]} … {x}^{[ T ]} ] = [ \begin{matrix}+ 1 & - 1 & + 1 & + 1 & + 1 & - 1 & + 1 & + 1 \\ + 1 & + 1 & - 1 & + 1 & + 1 & + 1 & - 1 & + 1 \\ + 1 & + 1 & + 1 & - 1 & + 1 & + 1 & + 1 & - 1 \\ - 1 & + 1 & + 1 & + 1 & - 1 & + 1 & + 1 & + 1 \\ + 1 & - 1 & + 1 & + 1 & - 1 & + 1 & - 1 & - 1 \\ + 1 & + 1 & - 1 & + 1 & - 1 & - 1 & + 1 & - 1 \\ + 1 & + 1 & + 1 & - 1 & - 1 & - 1 & - 1 & + 1 \\ - 1 & + 1 & + 1 & + 1 & + 1 & - 1 & - 1 & - 1\end{matrix} ]$$

Further, the channel estimation may be determined by the following:

$${H}_{est} = \frac{1}{T} {\sum }_{t = 1}^{T} {y}^{[ t ]} {x}^{[ t ] , H} = H \frac{1}{T} {\sum }_{t = 1}^{T} {x}^{[ t ]} {x}^{[ t ] , H} + \frac{1}{T} {\sum }_{t = 1}^{T} {n}^{[ t ]} {x}^{[ t ] , H}$$

The orthogonal code, P, may be designed such that:

$$\frac{1}{T} {\sum }_{t = 1}^{T} {x}^{[ t ]} {x}^{[ t ] , H} = I ,$$

and where the transmit signal and the noise are statistically independent:

$$\frac{1}{T} {\sum }_{t = 1}^{T} {n}^{[ t ]} {x}^{[ t ] , H} \approx 0$$

may hold. In case of a carrier frequency offset between the APs 105 (e.g., the first AP 105a transmits with f_{c} and the second AP 105b transmits with f_{c}+Δf), a STA 110 locked to f_{c} will receive the following:

$${y}^{[ t ]} = H [ \begin{matrix}{x}_{A P 1}^{[ t ]} \\ {x}_{A P 2}^{[ t ]} {e}^{j 2 π {tT}_{s y m} Δ f}\end{matrix} ] + n$$

In such instances, a channel estimation error may occur as the new term e^{j2πtT}^{_{sym}}^{Δf} introduced in the equation may change at every symbol, t. Hereby, T_{sym} may be the length of a symbol in time. In a joint sounding transmission, it may not be possible for a particular STA 110 to choose the correct carrier frequency, because at any time, the particular STA 110 may receive signals from the APs 105 with two carrier frequencies (e.g., a first carrier frequency associated with the first AP 105a and a second carrier frequency associated with the second AP 105b).

In such instances, the particular STA 110 may be able to choose the correct carrier frequency by changing the orthogonal code such that only one of the APs 105 may transmit at a time. The following code illustrates some example orthogonal code that may be associated with one of the APs 105 transmitting at a time:

$$P = [ {x}^{[ 1 ]} … {x}^{[ T ]} ] = [ \begin{matrix}+ 1 & - 1 & + 1 & + 1 & 0 & 0 & 0 & 0 \\ + 1 & + 1 & - 1 & + 1 & 0 & 0 & 0 & 0 \\ + 1 & + 1 & + 1 & - 1 & 0 & 0 & 0 & 0 \\ - 1 & + 1 & + 1 & + 1 & 0 & 0 & 0 & 0 \\ 0 & 0 & 0 & 0 & - 1 & + 1 & - 1 & - 1 \\ 0 & 0 & 0 & 0 & - 1 & - 1 & + 1 & - 1 \\ 0 & 0 & 0 & 0 & - 1 & - 1 & - 1 & + 1 \\ 0 & 0 & 0 & 0 & + 1 & - 1 & - 1 & - 1\end{matrix} ]$$

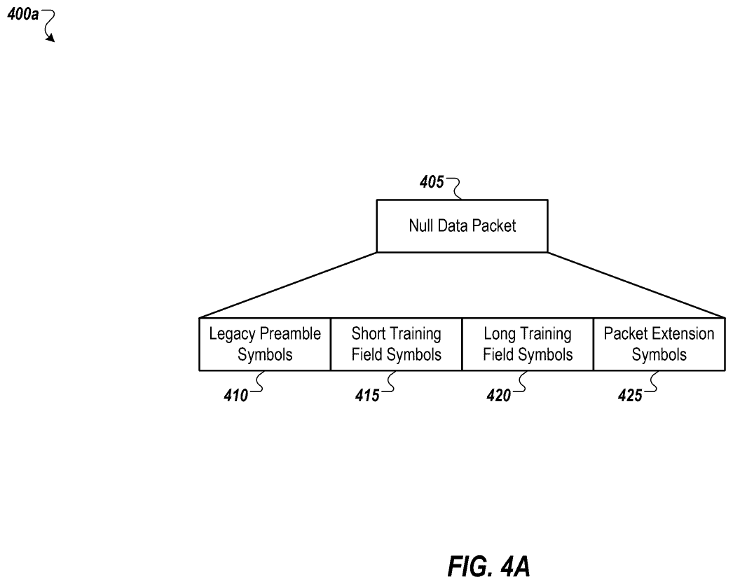

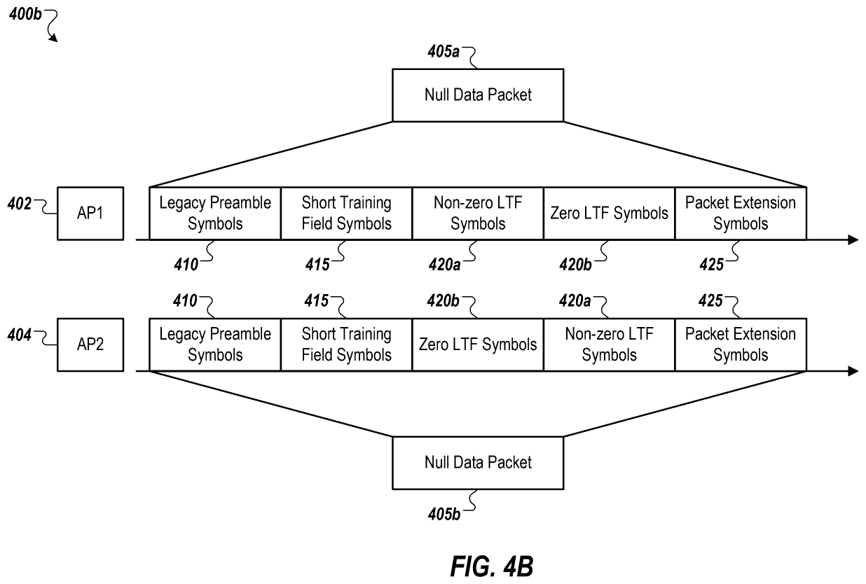

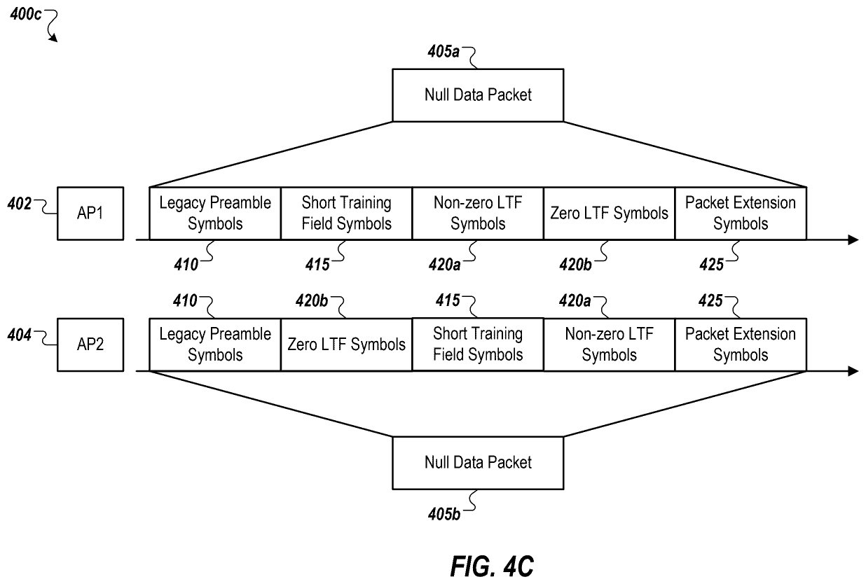

Using the orthogonal code, for the first symbols, t=1, . . . , T/2, the first AP 105a may transmit non-zero symbols and the second AP 105b may transmit zero symbols (e.g., as described and illustrated in FIGS. 4A-4C). For the symbols t=T/2+1, . . . , T, the second AP 105b may transmit non-zero symbols and the first AP 105a may transmit zero symbols.

For the STA 110 receivers, symbols from the first AP 105a may lock to a carrier frequency, f_{c}, and symbols from the second AP 105b may lock to a different carrier frequency, f_{c}+Δf, such that there may be no clock offset between transmitter and receiver at any time. As such, no channel estimation error may occur. Using the new sequence, the channel estimation equation may change to the following:

$${H}_{est} = \frac{{N}_{A P}}{T} {\sum }_{t = 1}^{T} {y}^{[ t ]} {x}^{[ t ] , H} ,$$

The updated channel estimation equation may account for some of the transmit signals being zeroed and may not contribute to the channel estimation. In the equation, N_{AP} (e.g., as illustrated in FIGS. 1, 2, and 3, N_{AP}=2) may be the number of APs. The described approach may cause minimal changes to the transmitter and the sounding sequence. However, the described approach may depend on the STAs readjusting the carrier frequency at a very short time between two symbols.

In some instances, to give a STA 110 more time to lock to the transmission from a different AP 105, the joint sounding NDP can be partitioned into two shorter packets. In such instances, the orthogonal code may be the length that corresponds to the TX antennas of one AP 105. An example orthogonal code for multiple, 4-antenna APs is provided below:

$$P = [ {x}^{[ 1 ]} … {x}^{[ T ]} ] = [ \begin{matrix}+ 1 & - 1 & + 1 & + 1 \\ + 1 & + 1 & - 1 & + 1 \\ + 1 & + 1 & + 1 & - 1 \\ - 1 & + 1 & + 1 & + 1\end{matrix} ]$$

FIG. 2 illustrates an example system 200 for WLAN multi-AP channel estimation. The system 200 may be similar to the system 100 of FIG. 1, and/or may include changes to the number of NDPs 220 transmitted from the APs 205 to the STAs 210. For example, the system 200 may facilitate a joint sounding sequence where the joint sounding NDP may be replaced by two NDPs 220 (that may be shorter than traditional NDPs) and a single NDP transmission for two overlapping BSS may be performed. The sounding sequence illustrated in FIG. 2 may be shorter than the sounding sequence illustrated in FIG. 1, where less packets may be transmitted between the APs 205 and the STAs 210. In such instances, transmitting less packets as part of the sounding sequence may result in a more efficient channel estimation.

As illustrated, the first AP 205a may transmit a trigger frame 235 to indicate a start of the joint sounding procedure. In some instances, the trigger frame 235 may facilitate the shortened sounding sequence illustrated in the system 200 relative to the sounding sequence associated with the system 100 of FIG. 1 by communicating to the various elements in the system 200 that a channel estimation may occur. Following the trigger frame 235, both the first AP 205a and the second AP 205b may transmit a NDPA 215, followed by each of the APs 205 transmitting individual NDPs 220. The first AP 205a may transmit the BFRP 225 to the STAs 210, and in response to obtaining the BFRP 225, the STAs 210 associated with the first AP 205a (e.g., the first STA 210a and the second STA 210b) may provide the CSI 230 associated with the channel between the first STA 210a and/or the second STA 210b, and the first AP 205a. Alternatively, or additionally, the second AP 205b may transmit the BFRP 225 to the STAs 210, and in response to obtaining the BFRP 225, the STAs 210 associated with the second AP 205b (e.g., the third STA 210c) may provide the CSI 230 associated with the channel between the STA 210c and the second AP 205b.

FIG. 3 illustrates an example system 300 for WLAN multi-AP channel estimation. The system 300 may be similar to the system 100 of FIG. 1 and/or the system 200 of FIG. 2, and/or the system 300 may include changes relative to the system 100, such as the number of NDPs 320 transmitted from the APs 305 to the STAs 310. For example, the system 300 may facilitate a joint sounding sequence where the joint sounding NDP may be replaced by two NDPs 320 (that may be shorter than traditional NDPs) and a single NDP transmission for two overlapping BSS may be performed. The sounding sequence illustrated in FIG. 3 may be shorter than the sounding sequence illustrated in FIG. 1, where less packets may be transmitted between the APs 305 and the STAs 310. In such instances, transmitting less packets as part of the sounding sequence may result in a more efficient channel estimation.

As illustrated, the first AP 305a may transmit a trigger frame 335 to indicate a start of the joint sounding procedure. In some instances, the trigger frame 335 may facilitate the shortened sounding sequence illustrated in the system 300 relative to the sounding sequence associated with the system 100 of FIG. 1 by communicating to the various elements in the system 300 that a channel estimation may occur. Following the trigger frame 335, the first AP 305a may transmit an NDPA 315 followed by the first AP 305a transmitting an NDP 320. Following the transmission of the NDPA 315 and the NDP 320 from the first AP 305a, the second AP 305b may transmit an NDPA 315 followed by an NDP 320. Following the NDP 320 transmitted by the second AP 305b, the first AP 305a may transmit the BFRP 325 to the STAs 310, and in response to obtaining the BFRP 325, the STAs 310 associated with the first AP 305a (e.g., the first STA 310a and the second STA 310b) may provide the CSI 330 associated with the channel between the first STA 310a and/or the second STA 310b, and the first AP 305a. Alternatively, or additionally, the second AP 305b may transmit the BFRP 325 to the STAs 310, and in response to obtaining the BFRP 325, the STAs 310 associated with the second AP 305b (e.g., the third STA 310c) may provide the CSI 330 associated with the channel between the STA 310c and the second AP 305b.

Using the described sounding sequences of the system 200 and 300 of FIGS. 2 and 3, respectively, the carrier frequency offset between the various APs may be a reduced or removed role relative to the carrier frequency in the prior approaches. The APs may send independent NDPs, and the CSI (e.g., the V Feedback packet), which the STAs transmit to the APs, may include of the information of the overall channel from all APs to the corresponding STA.

FIGS. 4A-4C illustrate example arrangements 400a, 400b, and 400c, respectively, that may be used in a WLAN multi-AP channel estimation system, such as the system 100, the system 200, and/or the system 300 as described herein.

The null data packet (NDP) 405 of the arrangement 400a illustrated in FIG. 4A may include multiple different symbols included therein. For example, the NDP 405 may include legacy packet preamble symbols 410, short training field (STF) symbols 415, long training field (LTF) symbols 420, and packet extension (PE) symbols 425. In some instances, the training field symbols (e.g., both the STF symbols 415 and the LTF symbols 420) may be used for MIMO channel estimation. When introducing zeros in the orthogonal code, P as described herein, one AP may stop transmitting for a part of the symbol, while another AP may begin transmission at substantially the same time.

In some instances, the internal structure of the NDPs may vary from the NDP 405 illustrated in the arrangement 400a. For example, FIG. 4B illustrates the arrangement 400b where the STF symbols 415 may be transmitted simultaneously by a first AP 402 and a second AP 404. The arrangement 400b illustrates that the LTF symbols 420 may be separated into non-zero LTF symbols 420a and zero LTF symbols 420b. Alternatively, or additionally, the first NDP 405a and the second NDP 405b may be arranged such that the non-zero LTF symbols 420a transmitted by the first AP 402 may temporally align with the zero LTF symbols 420b transmitted by the second AP 404, and/or the zero LTF symbols 420b transmitted by the first AP 402 may temporally align with the non-zero LTF symbols 420a transmitted by the second AP 404.

Alternatively, or additionally, the NDP 405 may vary from the NDP 405 illustrated in the arrangement 400a and/or may vary from the first NDP 405a and the second NDP 405b illustrated in the arrangement 400b. For example, FIG. 4C illustrates the arrangement 400c where the STF symbols 415 associated with the first NDP 405a may be transmitted by the first AP 402 when the second AP 404 may not be transmitting (e.g., transmitting the zero LTF symbols 420b), and the STF symbols 415 associated with the second NDP 405b may be transmitted by the second AP 404 when the first AP 402 may not be transmitting (e.g., transmitting the zero LTF symbols 420b). The arrangement 400c may allow the STA associated with the second AP 404 to synchronize to the new transmit clock within the STF symbols 415.

In a simulation, three rooms, two APs, and four STAs may be included. The APs may each have four antennas and the STAs may each have two antennas. The carrier frequency offset of ±0.07 ppm may be the standard requirement for uplink MU-MIMO transmission. The clock offset of a triggered multi-AP transmission may be expected to be in the same range.

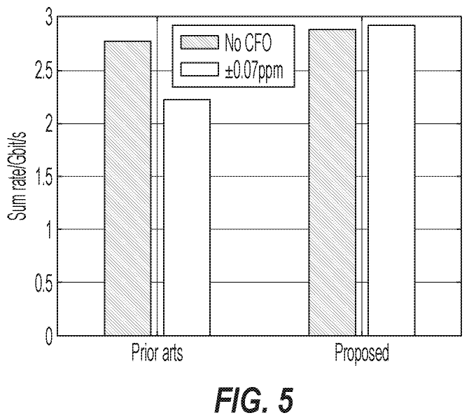

The sum data rates of the four STAs for prior approach sounding sequences (e.g., twice transmitted and overlapping NDPs) show a significant degradation due to the carrier frequency offset (CFO), as illustrated in FIG. 5. Alternatively, further illustrated in FIG. 5 is the joint sounding sequence according to the method described herein, where the simulation indicates that there may be no impact of the CFO. FIG. 5 may illustrate the sum data rate of two APs and two STAs associated with each AP, joint sounding and multi-AP coordinated transmission with spatial nulling.

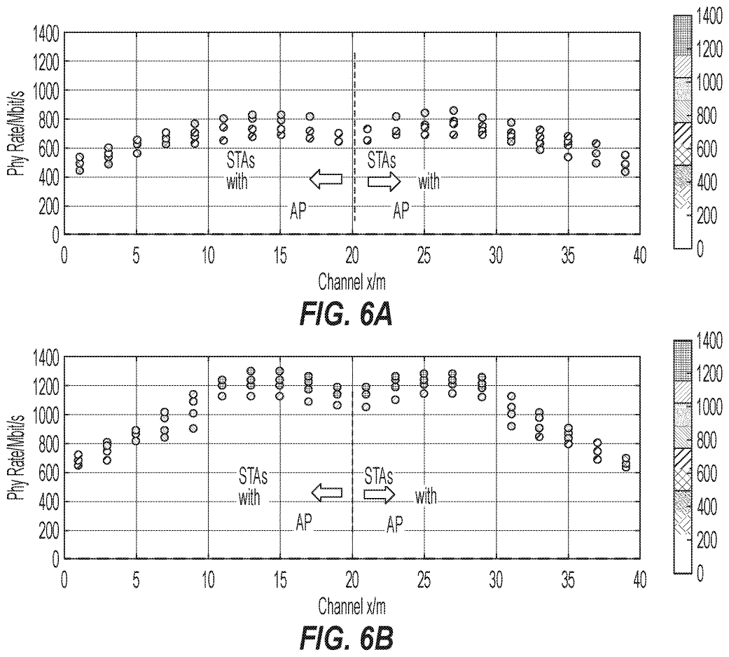

By implementing a joint optimization technique, improved results may be obtained as illustrated in FIGS. 6A and 6B. The feedback exchange phase may allow for jointly optimized precoding. In some instances, a best equalizer may be used rather than

$${U}_{s}^{H}$$

from joint sounding or

$${U}_{m s}^{H}$$

from independent sounding. FIG. 6A illustrates independent nulling and FIG. 6B illustrates joint optimization of nulling (where an average of 50% higher rates may be obtained).

In view of some of the simulations performed herein and illustrated in FIGS. 6A and 6B, sounding overhead may be improved by using a 20 ms sounding interval, which may allow for good spatial nulling performance. Alternatively, or additionally, without improvements, joint sounding overhead may be problematic (e.g., up to 20% overhead for two STAs per AP). In some instances, CFO in joint sounding may result in a channel estimation error (even in view of an aggressive assumption on pre-compensation), which may not be the same for sequential sounding. In some instances, independent sounding may be advantageous as dedicated feedback for data and/or nulling may be optimized for needs of the STAs and/or the APs (e.g., sounding for nulling may be performed on a less frequent basis). Alternatively, or additionally, feedback packets may have a particular recipient using independent sounding, which may allow for higher data rates.

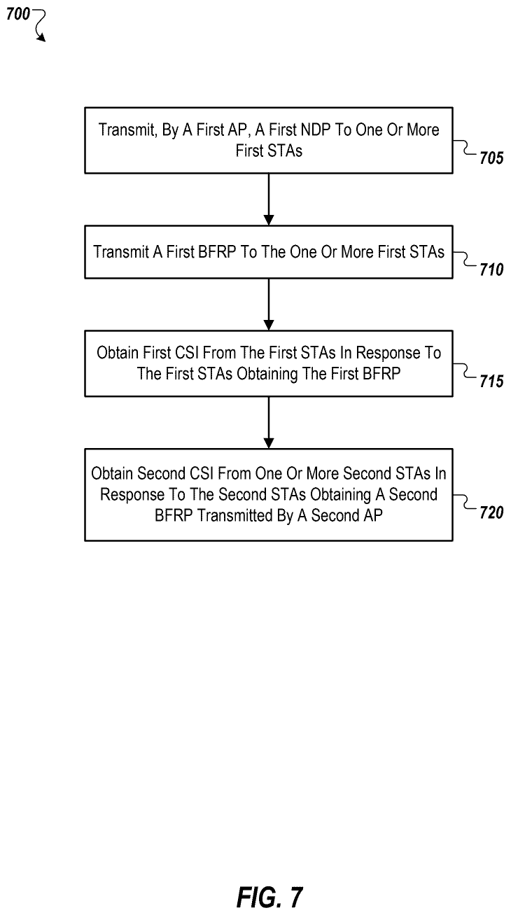

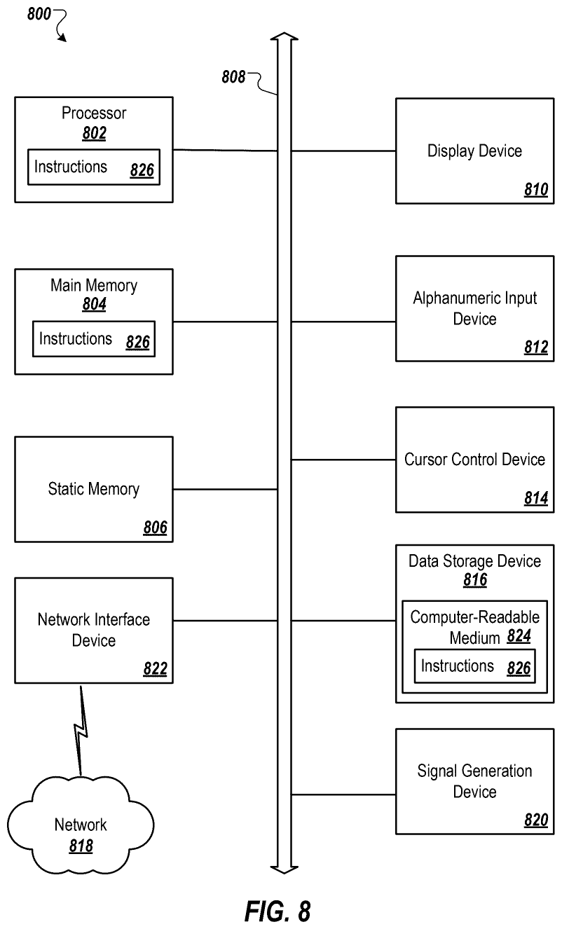

FIG. 7 illustrates a flowchart of an example method 700 for WLAN multi-AP channel estimation. The method 700 may be performed by processing logic that may include hardware (circuitry, dedicated logic, etc.), software (such as is run on a general purpose computer system or a dedicated machine), or a combination of both, which processing logic may be included in any computer system or device such as the first AP 105a, the second AP 105b of FIG. 1 (or any of the APs associated with the various figures described herein), and/or the computing device 800 of FIG. 8.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 700 may begin at block 705 where processing logic may transmit a first null data packet (NDP) to one or more first stations (STAs). The first NDP may be transmitted by a first access point (AP). In some instances, the first NDP is transmitted at a non-overlapping time interval with a second NDP transmitted from a second AP. In some instances, the first NDP may be modulated with an orthogonal code that may include non-zero values for the first AP and zero values for the second AP.

In some instances, the first NDP may include legacy preamble symbols, short training field (STF) symbols, long training field (LTF) symbols, and/or packet extension (PE) symbols. The LTF symbols may include non-zero value LTF symbols and zero value LTF symbols. In some instances, the first NDP may be arranged as the legacy preamble symbols, the STF symbols, the non-zero value LTF symbols, zero value LTF symbols, and PE symbols. Alternatively, or additionally, the second NDP may be arranged as legacy preamble symbols, STF symbols, zero value LTF symbols, non-zero value LTF symbols, and PE symbols.

At block 710, the processing logic may transmit a first beamforming report poll (BFRP) to the one or more first STAs. The first BFRP may be transmitted by the first AP.

At block 715, the processing logic may obtain first channel state information (CSI) from the one or more first STAs in response to the one or more first STAs obtaining the first BFRP.

At block 720, the processing logic may obtain second CSI from one or more second STAs in response to the one or more second STAs obtaining a second BFRP transmitted by the second AP.

Modifications, additions, or omissions may be made to the method 700 without departing from the scope of the present disclosure. For example, the processing logic may transmit a first NDP announcement (NDPA) prior to the first NDP. The first NDPA may be transmitted by the first AP. Alternatively, or additionally, the first NDPA may be transmitted at a non-overlapping time interval with a second NDPA transmitted by the second AP.

In another example, the designations of different elements in the manner described is meant to help explain concepts described herein and is not limiting. Further, the method 700 may include any number of other elements or may be implemented within other systems or contexts than those described.

FIG. 8 illustrates an example computing device 800 within which a set of instructions, for causing the machine to perform any one or more of the methods discussed herein, may be executed. The computing device 800 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 800 includes a processing device 802 (e.g., a processor), a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

The processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one implementation, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system, comprising:
a first access point (AP) operable to transmit a first null data packet (NDP);
a second AP operable to transmit a second NDP;
one or more first stations (STAs) associated with the first AP, operable to transmit first channel state information (CSI) to the first AP and the second AP in response to obtaining a first beamforming report poll (BFRP) from the first AP; and
one or more second STAs associated with the second AP, operable to transmit second CSI to the first AP and the second AP in response to obtaining a second BFRP from the second AP,
wherein the first NDP and the second NDP are transmitted at non-overlapping time intervals.

2. The system of claim 1, wherein:
the first AP is operable to transmit a first NDP announcement (NDPA) prior to the first NDP;
the second AP is operable to transmit a second NDPA prior to the second NDP; and
a trigger frame is transmitted prior to the first NDPA and the second NDPA.

3. The system of claim 2, wherein the first NDPA and the second NDPA are transmitted at non-overlapping time intervals.

4. The system of claim 1, wherein the first NDP is modulated with an orthogonal code that comprises non-zero values for the first AP and zero values for the second AP.

5. The system of claim 1, wherein a number of symbols included in the first NDP may be based on a first number of antennas of the first AP and a second number of antennas of the second AP.

6. The system of claim 1, wherein the first NDP comprises legacy preamble symbols, short training field (STF) symbols, long training field (LTF) symbols, and packet extension (PE) symbols.

7. The system of claim 6, wherein:
the LTF symbols comprise non-zero value LTF symbols and zero value LTF symbols;
the first NDP is arranged as the legacy preamble symbols, the STF symbols, the non-zero value LTF symbols, zero value LTF symbols, and PE symbols; and
the second NDP is arranged as legacy preamble symbols, STF symbols, zero value LTF symbols, non-zero value LTF symbols, and PE symbols.

8. The system of claim 6, wherein non-zero value symbols of the LTF symbols are preceded by the STF symbols, and zero value symbols of the LTF symbols are not preceded by the STF symbols.

9. An access point (AP), comprising:
a transceiver operable to communicate with at least a second AP and one or more first stations (STAs);
a processing device operable to:
transmit a first null data packet (NDP);
transmit a first beamforming report poll (BFRP);
obtain first channel state information (CSI) from the one or more first STAs in response to the one or more first STAs obtaining the first BFRP;
obtain second CSI from one or more second STAs in response to the one or more second STAs obtaining a second BFRP transmitted by the second AP,
wherein the first NDP is transmitted at a non-overlapping time interval with a second NDP transmitted by the second AP.

10. The AP of claim 9, wherein:
a first NDP announcement (NDPA) is transmitted prior to the first NDP; and
a trigger frame is transmitted prior to the first NDPA.

11. The AP of claim 10, wherein the first NDPA is transmitted at a non-overlapping time interval with a second NDPA transmitted by the second AP.

12. The AP of claim 9, wherein the first NDP is modulated with an orthogonal code that comprises non-zero values for the first AP and zero values for the second AP.

13. The AP of claim 9, wherein a number of symbols included in the first NDP may be based on a first number of antennas of the first AP and a second number of antennas of the second AP.

14. The AP of claim 9, wherein the first NDP comprises legacy preamble symbols, short training field (STF) symbols, long training field (LTF) symbols, and packet extension (PE) symbols.

15. The AP of claim 14, wherein:
the LTF symbols comprise non-zero value LTF symbols and zero value LTF symbols;
the first NDP is arranged as the legacy preamble symbols, the STF symbols, the non-zero value LTF symbols, zero value LTF symbols, and PE symbols; and
the second NDP is arranged as legacy preamble symbols, STF symbols, zero value LTF symbols, non-zero value LTF symbols, and PE symbols.

16. The AP of claim 14, wherein non-zero value symbols of the LTF symbols are preceded by the STF symbols, and zero value symbols of the LTF symbols are not preceded by the STF symbols.

17. A method, comprising:
transmitting, by a first access point (AP), a first null data packet (NDP) to one or more first stations (STAs);
transmitting, by the first AP, a first beamforming report poll (BFRP) to the one or more first STAs;
obtaining first channel state information (CSI) from the one or more first STAs in response to the one or more first STAs obtaining the first BFRP;
obtaining second CSI from one or more second STAs in response to the one or more second STAs obtaining a second BFRP transmitted by a second AP,
wherein the first NDP is transmitted at a non-overlapping time interval with a second NDP transmitted by the second AP.

18. The method of claim 17, further comprising:
transmitting, by the first AP, a trigger frame; and
transmitting, by the first AP, a first NDP announcement (NDPA) prior to the first NDP and after the trigger frame, wherein the first NDPA is transmitted at a non-overlapping time interval with a second NDPA transmitted by the second AP.

19. The method of claim 17, wherein the first NDP is modulated with an orthogonal code that comprises non-zero values for the first AP and zero values for the second AP.

20. The method of claim 17, wherein:
the first NDP comprises legacy preamble symbols, short training field (STF) symbols, long training field (LTF) symbols, and packet extension (PE) symbols;
the LTF symbols comprise non-zero value LTF symbols and zero value LTF symbols;
the first NDP is arranged as the legacy preamble symbols, the STF symbols, the non-zero value LTF symbols, zero value LTF symbols, and PE symbols; and
the second NDP is arranged as legacy preamble symbols, STF symbols, zero value LTF symbols, non-zero value LTF symbols, and PE symbols.
